(19) United States
(12) Patent Application Publication
(10) Pub. No.: US 2026/0165240 A1
(43) Pub. Date: Jun. 18, 2026

(54) MOWER DISCHAGE CHUTE ASSEMBLY AND MOWER

(71) Applicant: KUBOTA CORPORATION, Osaka-shi (JP)

(72) Inventor: Chris TOOMBS, Gainesville, GA (US)

(73) Assignee: KUBOTA CORPORATION, Osaka-shi (JP)

(21) Appl. No.: 18/986,620

(22) Filed: Dec. 18, 2024

(51) Int. Cl. A01D 34/71

(52) U.S. Cl. CPC A01D 34/71

(57) ABSTRACT

A mower discharge chute assembly includes a first side plate, a folding top cover, and a coupler. The first side plate is configured to cover a side opening of a mower deck. The folding top cover is connected to the first side plate. The folding cover is foldable to have the side opening covered by the first side plate and unfoldable to have the side opening uncovered. The folding top cover includes top plates configured to be stacked when the folding top cover is folded. The coupler is provided on the mower deck adjacent to the side opening to movably couple the folding top cover to the mower deck.

### BACKGROUND

### TECHNICAL FIELD

The present invention relates to a mower discharge chute assembly and a mower. More specifically, the present invention relates to a retractable mower discharge chute assembly and a mower having the retractable mower discharge chute assembly therein.

### DISCUSSION OF THE BACKGROUND

US 6,971,224 B1 describes a retractable mower discharge chute assembly and a mower. The mower discharge chute assembly has a complicated structure and requires many components.

An objective of a technology disclosed in the present application is to provide a retractable mower discharge chute assembly that has a simpler structure than the prior art has.

### SUMMARY

In accordance with one aspect of the present disclosure, a mower discharge chute assembly includes a first side plate, a folding top cover, and a coupler. The folding top cover is connected to the first side plate. The folding cover is foldable to have the side opening covered by the first side plate and unfoldable to have the side opening uncovered. The folding top cover includes top plates configured to be stacked when the folding top cover is folded. The coupler is provided on the mower deck adjacent to the side opening to movably couple the folding top cover to the mower deck.

In accordance with another aspect of the present disclosure, a mower includes a cutting blade, a mower deck, a drive train, and a mower discharge chute assembly. The cutting blade is rotatable to produce clippings. The mower deck rotatably supports the cutting blade and having an inner top surface facing the cutting blade and an outer top surface opposite to the inner top surface. The mower deck has a side opening positioned to allow for discharge of the clippings. The drive train is provided on the outer top surface of the mower deck. The mower discharge chute assembly coupled to the mower deck and configured to open and close the side opening. The mower discharge chute assembly includes a first side plate, a folding top cover, and a coupler. The first side plate is configured to cover the side opening. The folding top cover is foldable to have the side opening covered by the first side plate and unfoldable to have the first side plate uncovered. The folding top cover includes top plates configured to be stacked when the folding top cover is folded. The coupler is provided on the outer top surface of the mower deck adjacent to the side opening to movably couple the folding top cover to the outer top surface.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 shows a perspective view of the mower with a side opening opened.

FIG. 2 shows a perspective view of the mower with a side opening closed.

FIG. 3 shows a bottom view of the mower with a side opening opened.

FIG. 4 shows a perspective view of a drive train of the mower.

FIG. 5 shows an enlarged perspective view of the mower discharge chute assembly when the folding top cover is unfolded.

FIG. 6 shows a bottom view of the mower discharge chute assembly when the folding top cover is unfolded.

FIG. 7 shows an exploded bottom view of the mower discharge chute assembly when the folding top cover is unfolded.

FIG. 8 shows an exploded top view of the mower discharge chute assembly when the folding top cover is unfolded.

FIG. 9 shows a bottom view of the mower discharge chute assembly when the folding top cover is folded.

FIG. 10 shows another enlarged perspective view of the mower discharge chute assembly when the folding top cover is unfolded.

FIG. 11 shows an enlarged perspective view of the mower discharge chute assembly when the folding top cover is folded.

FIG. 12 shows an enlarged top view of another mower discharge chute assembly when the folding top cover is unfolded.

FIG. 13 shows an exploded bottom view of the mower discharge chute assembly shown in FIG. 12 when the folding top cover is unfolded.

FIG. 14 shows an exploded top view of the mower discharge chute assembly shown in FIG. 12 when the folding top cover is unfolded.

### DESCRIPTION OF THE EMBODIMENTS

### <Mower>

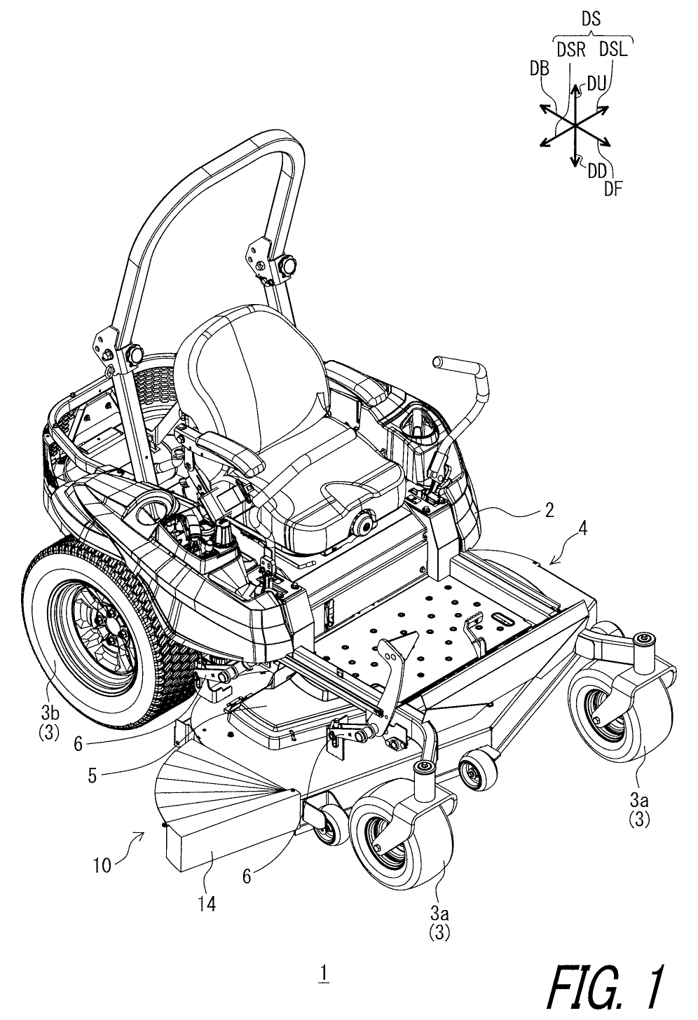

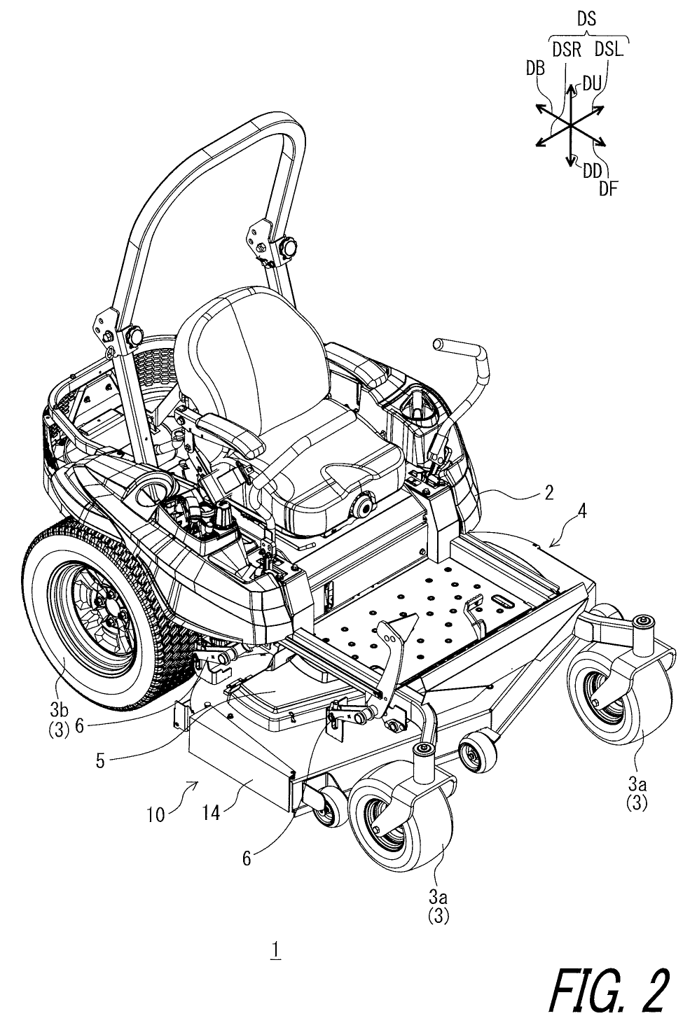

FIGS. 1 and 2 are perspective view of a mower 1 according to an embodiment of the present disclosure. The mower 1 is configured to cut grass and other vegetation. The mower 1 includes a vehicle frame 2, wheels 3, a mower deck 4, a deck cover 5, a deck lift 6, and a mower discharge chute assembly 10. The vehicle frame 2 supports the wheels 3 and the deck lift 6. The vehicle frame 2 serves as the structural backbone of the mower 1, providing the necessary support and stability for the wheels 3, the deck lift 6, and other components of the mower 1. The vehicle frame 2 is designed to withstand the stresses and strains of mower operation, ensuring the mower's durability and longevity.

The wheels 3 are attached to the vehicle frame 2 to move the vehicle frame 2. The wheels 3 include front wheels 3a, and rear wheels 3b. The wheels 3 are attached to the vehicle frame 2. Each of the rear wheels 3b are driven by respective hydraulic motors (not shown), thereby the rear wheels 3b can rotate in the same direction or opposite directions. The mower 1 can move in both a front direction DF and a rear direction DB opposite to the front direction DF when the rear wheels 3b rotate in the same direction and the same speed. In this embodiment, a bilateral direction including the front direction DF and the rear direction DB can be referred to as a front-rear direction DFB. The mower 1 can turn to either a leftward direction DSL or a rightward direction DSR depending on the speed and the direction in which each of the rear wheels 3b rotates. In this embodiment, a bilateral direction including the leftward direction DSL and the rightward direction DSR can be referred to as a side direction DS.

The mower deck 4 covers cutting blades 7 (explained later). The deck cover 5 covers main components of a drive train 8 (explained later) configured to rotate the cutting blades 7. The deck cover 5 covers the main components to protect them. The deck cover 5 may be removable to allow easy access for maintenance and repairs of the drive train 8. The deck lift 6 supports the mower deck 4 so that the deck lift 6 can move the mower deck 4 in the upward direction DU and in the downward direction DD. This allows for the customization of the cutting height, enabling the user to achieve a desired grass length.

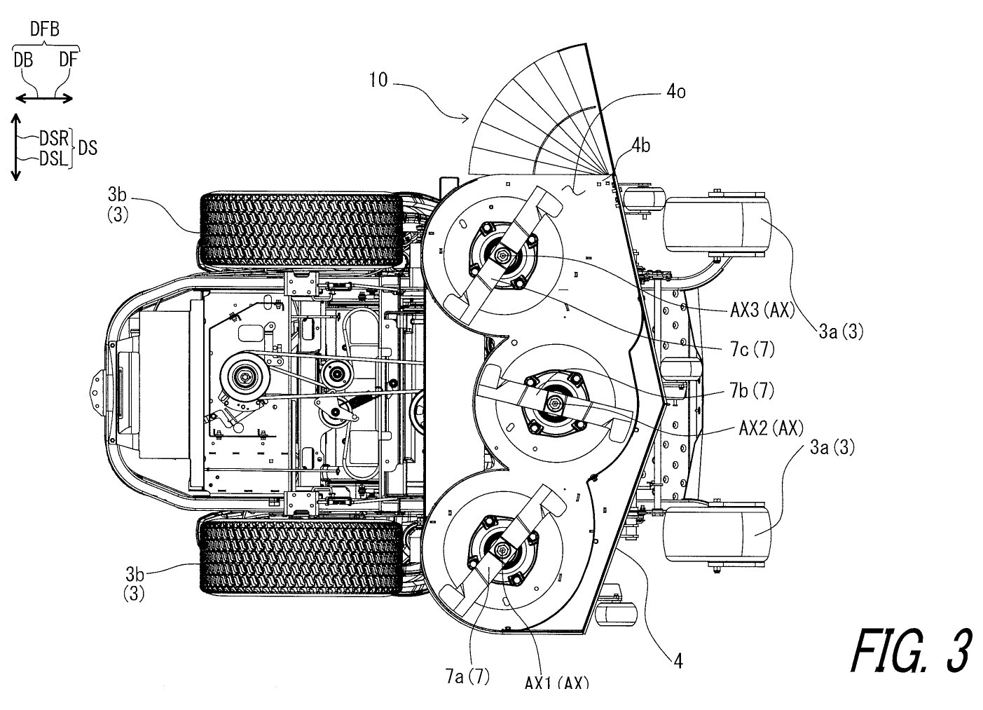

FIG. 3 shows a bottom view of the mower 1. As shown in FIG. 3, the mower 1 includes cutting blades 7 rotatable around rotational axes AX to produce clippings of grass. In this embodiment, the number of the cutting blades 7 are three. However, mower 1 may have a different number of cutting blades 7. The mower deck 4 rotatably supports the cutting blades 7. More specifically, the mower deck 4 has an inner top surface 4b facing the cutting blades 7. More specifically, the cutting blades 7 includes a first cutting blade 7a, a second cutting blade 7b, and a third cutting blade 7c. The first cutting blade 7a, the second cutting blade 7b, and the third cutting blade 7c are rotatable around a first rotational axis AX1, a second rotational axis AX2, and a third rotational axis AX3, repectively.

As shown in FIG. 3, the mower deck 4 is designed with a shape that optimizes grass cutting and discharge, featuring a curved or angled profile to direct clippings towards the mower discharge chute assembly 10. The mower deck 4 has a side opening 4o positioned to allow for discharge of the clippings. The mower discharge chute assembly 10 is positioned adjacent to the side opening 4o and directs the flow of the clippings away from the mower 1. The mower discharge chute assembly 10 is designed to efficiently channel grass clippings, preventing clogging and ensuring a clean discharge.

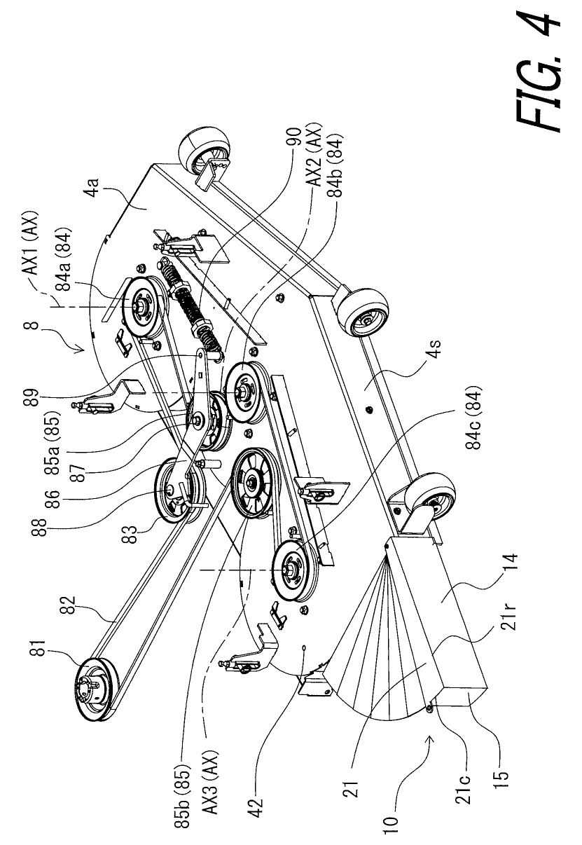

FIG. 4 shows an outer view of the mower deck 4 without the deck cover 5. As shown in FIGS. 1, 2, and 4, the mower deck 4 has an outer top surface 4a opposite to the inner top surface 4b. The mower deck 4 is typically constructed from sturdy materials such as steel tubing or reinforced aluminum to ensure durability and stability during operation. In alternative embodiments, the mower deck 4 may be constructed from lightweight composite materials to reduce overall weight while maintaining strength.

FIG. 4 illustrates a perspective view of the drive train 8 provided on the mower deck 4. The drive train 8 is provided on the outer top surface 4a of the mower deck 4. The drive train 8 includes a drive pulley 81, a drive belt 82, an idler pulley 83, driven pulleys 84, tensioning pulleys 85, an idler arm 86, a pivot 87, an axle 88, a spring connection point 89, and a tension spring 90. The mower deck 4 provides mounting points for components of the drive train 8.

The drive pulley 81 is the primary power input for the drive train 8. It is typically connected to a prime mover (not shown) that configured to configured to rotate to drive the drive belt 82. Typically, the prime mover is an internal combustion engine, but alternative embodiments may utilize electric motors or hydraulic power systems. Features such as a clutch mechanism to engage or disengage the drive pulley 81 with the prime mover may be incorporated between the drive pulley 81 and the prime mover.

The drive belt 82 is a continuous loop that transfers power from the drive pulley 81 to the driven pulleys 84. More specifically, the drive belt 82 loops around the drive pulley 81, the idler pulley 83, the driven pulleys 84, and the tensioning pulleys 85. The drive belt 82 is typically made of reinforced rubber or synthetic materials designed for high flexibility and durability. The drive belt 82 may have a V-shaped or multi-ribbed profile to increase grip on the pulleys. Some advanced designs may incorporate embedded fibers or sensors to monitor belt wear and tension.

The driven pulleys 84 are connected to the cutting blade spindles and rotate to power the cutting blades 7. These spindles may incorporate bearings and seals to ensure smooth operation and prevent contamination. The driven pulleys 84 are connected to the cutting blades 7, respectively. In this embodiment, the number of driven pulleys 84 are three. However, the drive train 8 may have a different number of driven pulleys 84. More specifically, the driven pulleys 84 include a first driven pulley 84a, a second drive pulley 84b, and a third drive pulley 84c respectively connected to the first cutting blade 7a, the second cutting blade 7b, and the third cutting blade 7c. In some embodiments, the driven pulleys 84 may have different diameters to achieve varying blade speeds across the mower deck. The tensioning pulleys 85 are engages with the drive belt 82 to ensure efficient power transfer and prevent belt slippage.

The idler pulley 83 is mounted on the idler arm 86 to be rotatable around the axle 88. The idler pulley 83 is configured to be engaged by the drive belt 82 to provide tension. The tension spring 90 is connected to the spring connection point 89 of the idler arm 86 and configured to pull the idler arm 86 to rotate the idler arm 86 around the pivot 87 to move the idler pulley 83 such that the idler pulley 83 provides a proper tension. Each of the drive pulley 81, the idler pulley 83, the driven pulleys 84, and the tensioning pulleys 85 are typically made of durable materials such as steel or high-strength plastics and incorporates sealed bearings for smooth operation. Each of the drive pulley 81, the idler pulley 83, the driven pulleys 84, and the tensioning pulleys 85 may have a flat or grooved surface depending on the belt design and tension requirements.

In operation, power is transferred from the prime mover to the drive pulley 81, which rotates the drive belt 82. The drive belt 82 then transfers this rotational power to the driven pulleys 84 which in turn power the cutting blades 7. The tensioning pulleys 85 and the idler arm 86, the idler pulley 83, and the tension spring 90 work together to maintain proper belt tension throughout the system, ensuring efficient power transfer and prolonging belt life. However, the mower 1 may have a different structure of the drive train 8.

### <Overall structure of the mower drive belt tensioner>

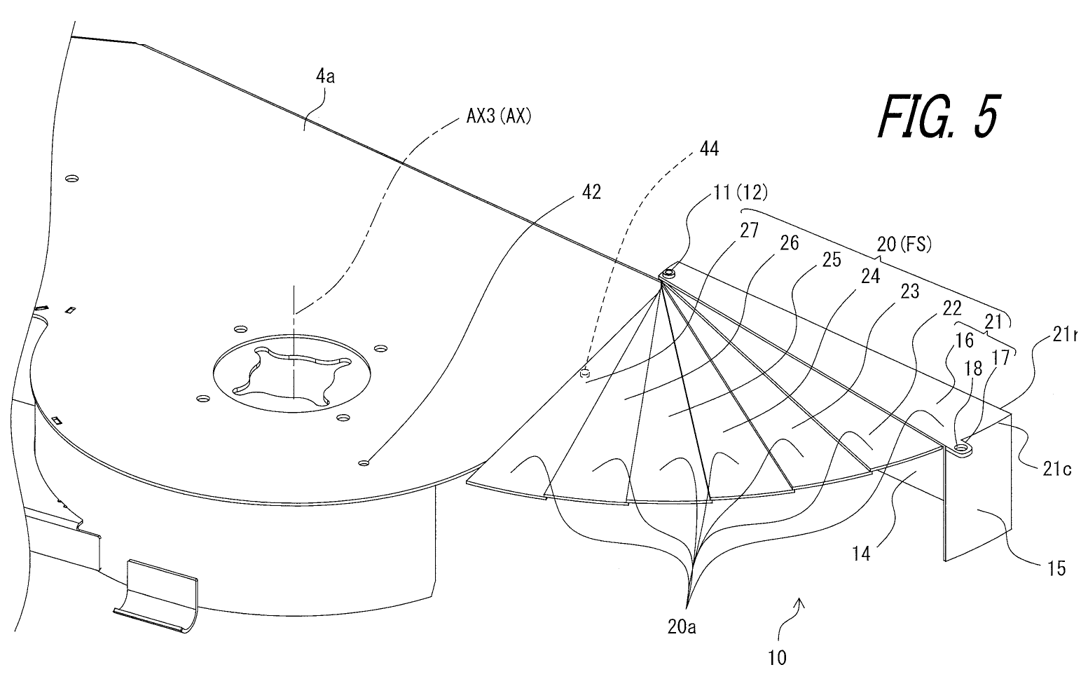

As shown in FIGS. 1 and 2, the mower discharge chute assembly 10 is coupled to the mower deck 4 and configured to open and close the side opening 4o. FIG. 5 shows an enlarged perspective view of the mower discharge chute assembly 10. As shown in FIG. 5, the mower discharge chute assembly 10 includes a first side plate 14, a folding top cover 20, and a coupler 11. The first side plate 14 is configured to cover the side opening 4o of the mower deck 4. The folding top cover 20 is connected to the first side plate 14. The folding top cover 20 is foldable to have the side opening 4o covered by the first side plate 14. he folding top cover 20 is unfoldable to have the side opening 4o uncovered. FIG. 5 shows the folding top cover 20 which is unfolded. The coupler 11 is provided on the outer top surface 4a of the mower deck 4 adjacent to the side opening 4o to movably couple the folding top cover 20 to the outer top surface 4a of the mower deck 4.

The folding top cover 20 includes top plates 21 to 27 configured to be stacked when the folding top cover 20 is folded. The top plates 21 to 27 are provided on the outer top surface 4a of the mower deck 4. In this embodiment, each of the top plates 21 to 27 is fan-shaped. The coupler 11 includes a pivot 12 of the fan-shaped top plates 21 to 27. The top plates 21 to 27 include a distal top plate 21 coupled to the first side plate14, and a proximal top plate 27 provided opposite to the distal top plate 21 such that the proximal top plate 27 is closest to the mower deck 4 among the top plates 21 to 27 when the folding top cover 20 is unfolded. More specifically, the first side plate 14 is coupled to a radius side 21r of the fan-shaped distal top plate 21.

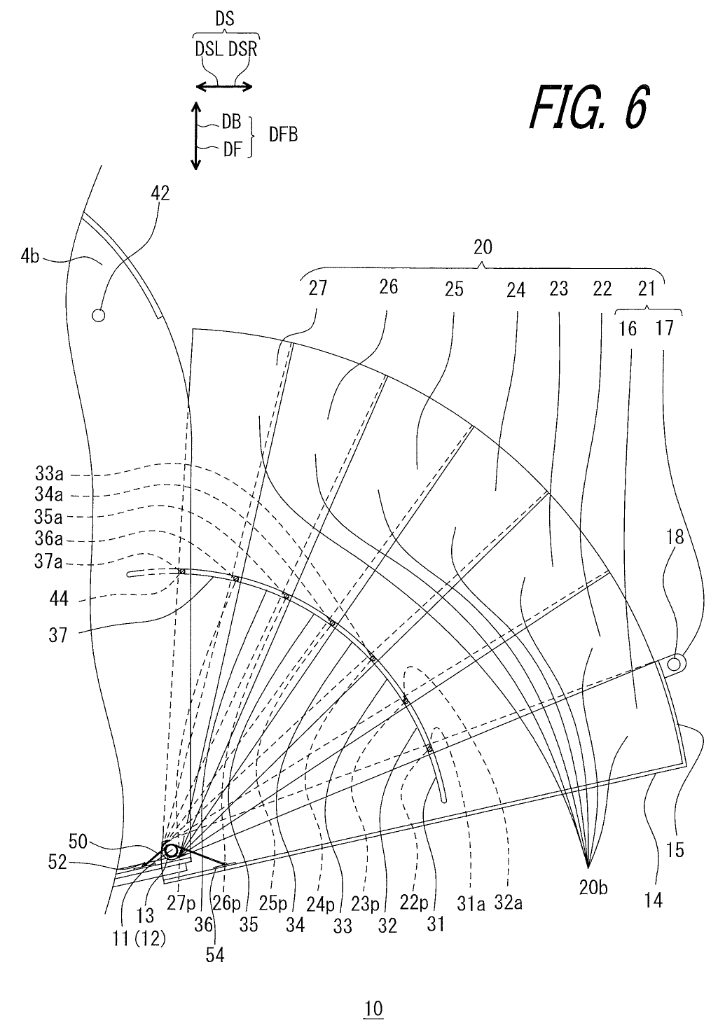

FIG. 5 shows top surfaces 20a of the top plates 21 to 27. FIG. 6 shows a bottom view of the mower discharge chute assembly 10 when folding top cover 20 is unfolded. That is, FIG. 6 shows bottom surfaces 20b of the top plates 21 to 27 which are opposite to the top surfaces 20a along the pivot 12. As shown in FIG. 6, each of the top plates 21 to 27 has a through hole 13 through which the pivot 12 passes. Each of the top plates 21 to 27 has guide grooves 31 to 37 on their bottom surfaces 20b, respectively. The top plates 22 to 27 have protrusions 22p to 27p on their top surfaces 20a, respectively. The guide grooves 31 to 37 each have an arc shape with respect to the pivot 12. The protrusions 22p to 27p are engageable with the guide grooves 31 to 36. The mower discharge chute assembly 10 further includes a protrusion 44 provided on the outer top surface 4a of the mower deck 4. The protrusion 44 is engaged with the guide groove 37 provided on the bottom surface 20b of the proximal top plate 27. The protrusions 22p to 27p and 44 are formed by rivets, additive manufacturing, or mill processing.

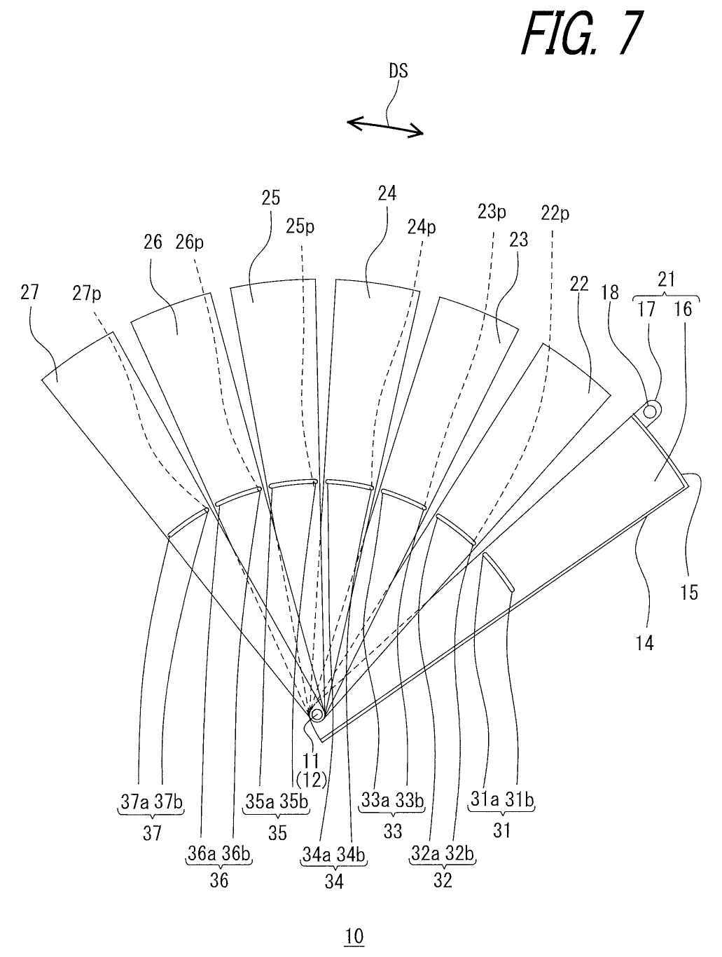

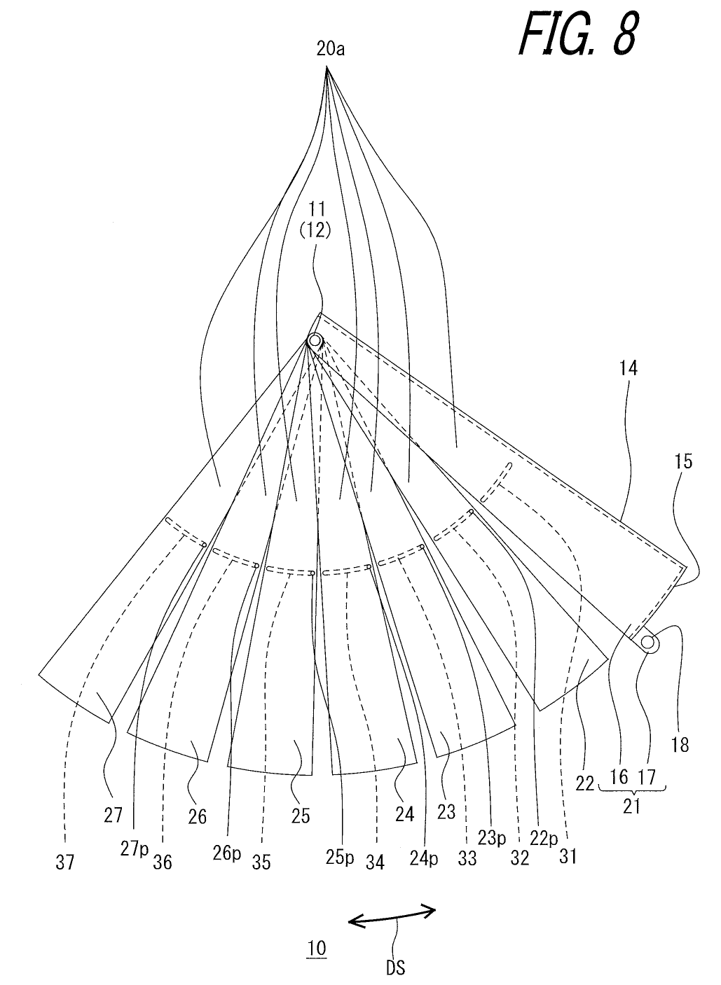

FIG. 7 shows an exploded bottom view of the mower discharge chute assembly 10 when folding top cover 20 is unfolded. FIG. 8 shows an exploded top view of the mower discharge chute assembly 10 when folding top cover 20 is unfolded. As shown in FIGS. 7 and 8, the guide grooves 31 to 36 have first groove ends 31a to 36a against which the protrusions 22p to 27p abut, respectively, when the folding top cover 20 is unfolded. The guide groove 37 has a first groove end 37a against which the protrusion 44 abuts when the folding top cover 20 is unfolded.

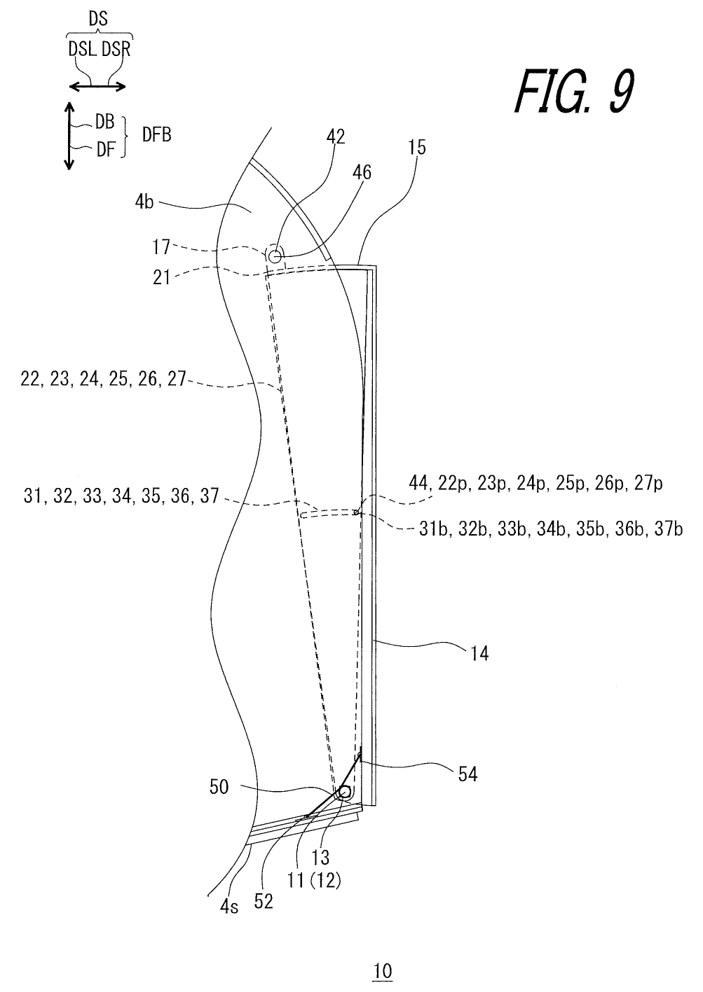

As shown in FIG. 7, the guide grooves 31 to 36 have second groove ends 31b to 36b opposite to the first groove ends 31a to 36a in a circumferential direction DC with respect to the pivot 12. FIG. 9 shows a bottom view of the mower discharge chute assembly 10 when folding top cover 20 is folded. As shown in FIGS. 7 and 9, the second groove ends 31b to 36b are configured to abut against the protrusions 22p to 27p to fold the top plates 21 to 26 when the first side plate 14 covers the side opening 4o. The guide groove 37 has a second groove end 37b opposite to the first groove end 37a in the circumferential direction DC with respect to the pivot 12. The second groove end 37b is configured to abut against the protrusion 44 to fold the top plates 21 to 27 when the first side plate 14 covers the side opening 4o. Accordingly, the second groove ends 31b to 37b are configured to abut against the protrusions 22p to 26p and 44 to fold the top plates 21 to 27 when the first side plate 14 covers the side opening 4o.

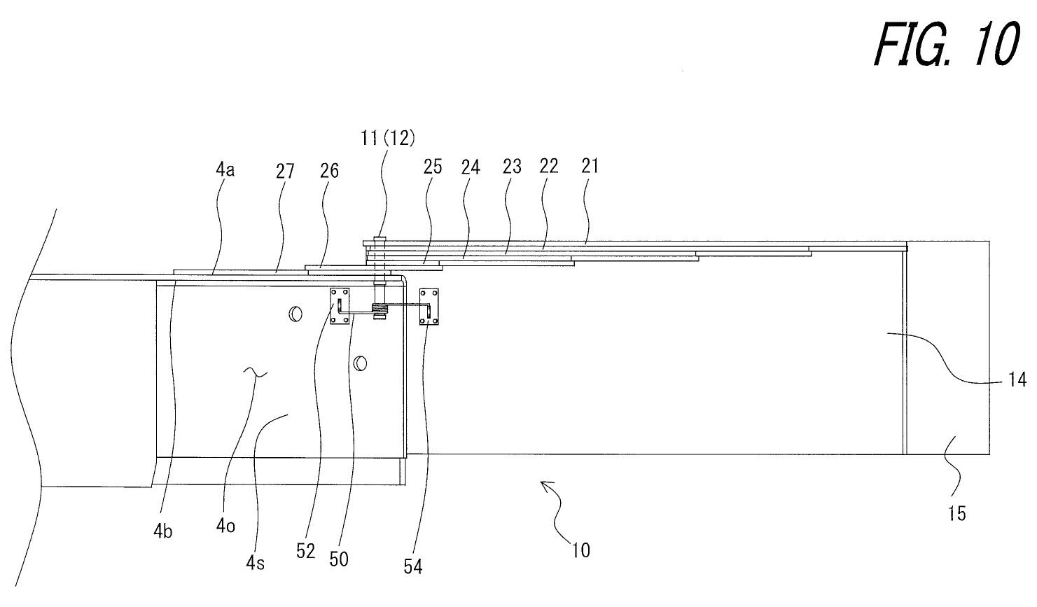

FIG. 10 shows another enlarged perspective view of the mower discharge chute assembly 10 when folding top cover 20 is unfolded. As shown in FIGS. 6, 9 and 10, the mower discharge chute assembly 10 further includes a spring 50 configured to press the first side plate 14 and a side wall 4s of the mower deck 4 to urge the folding top cover 20 to open. More specifically, the spring 50 is preferably a torsion spring. However, other types of spring may be used. The spring 50 is disposed around the pivot 12. As seen in FIG. 10, the spring 50 is attached to the side wall 4s of the mower deck 4 via a hook 52. The spring 50 is attached to the first side plate 14 via a hook 54. However, the hooks 52, 54 are mere examples, other means of attachment may be used.

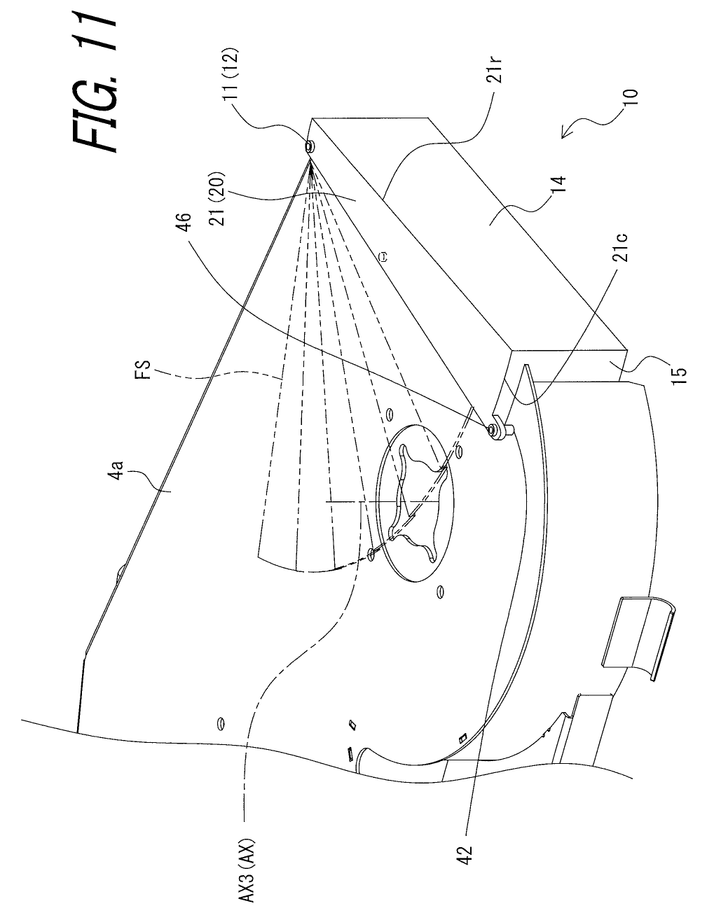

FIG. 11 shows an enlarged perspective view of the mower discharge chute assembly 10 when the folding top cover 20 is folded. As seen in FIGS. 4, 5, and 11, the mower discharge chute assembly 10 further includes a second side plate 15 coupled to an arc side 21c of the fan-shaped distal top plate 21. As seen in FIG. 11, the second side plate 15 is configured to cover a rear portion of the side opening 4o.

Furthermore, the mower discharge chute assembly 10 further includes a lock pin 46 configured to keep the folding top cover 20 folded. As seen in FIGS. 5, 6, 9, and 11, the mower discharge chute assembly 10 further includes first pin hole 42 provided on the mower deck 4 adjacent to the top plates 21 to 27 stacked when the folding top cover 20 is folded. The lock pin 46 is configured to pass through the first pin hole 42. As shown in FIGS. 5 to 8, the distal top plate 21 has a fan-shaped portion 16 and a projection 17 protruding from the fan-shaped portion 16. The projection 17 has a second pin hole 18 through which the lock pin 46 is configured to pass. The second pin hole 18 is aligned with the first pin hole 42 along the pivot 12 when the folding top cover 20 is folded.

FIGS. 5 and 11 show the third rotational axis AX3 of the third cutting blade 7c. As shown in FIGS. 2 and 11, the stacked top plates 21 to 27 do not interface with the drive train 8 when the folding top cover 20 is closed. As shown in FIG. 5, the folding top cover 20 has a shape FS of an unfolded fan when the folding top cover 20 is unfolded. As shown in FIG. 11, the folding top cover 20 interferes with the drive train 8 if the folding top cover 20 has the shape FS of the unfolded fan when the first side plate 14 covers the side opening 4o. In FIG. 11, the shape FS of the unfolded fan is depicted in two-dot chain lines. More specifically, the shape FS overlaps with the third rotational axis AX3 as viewed along the third rotational axis AX3.

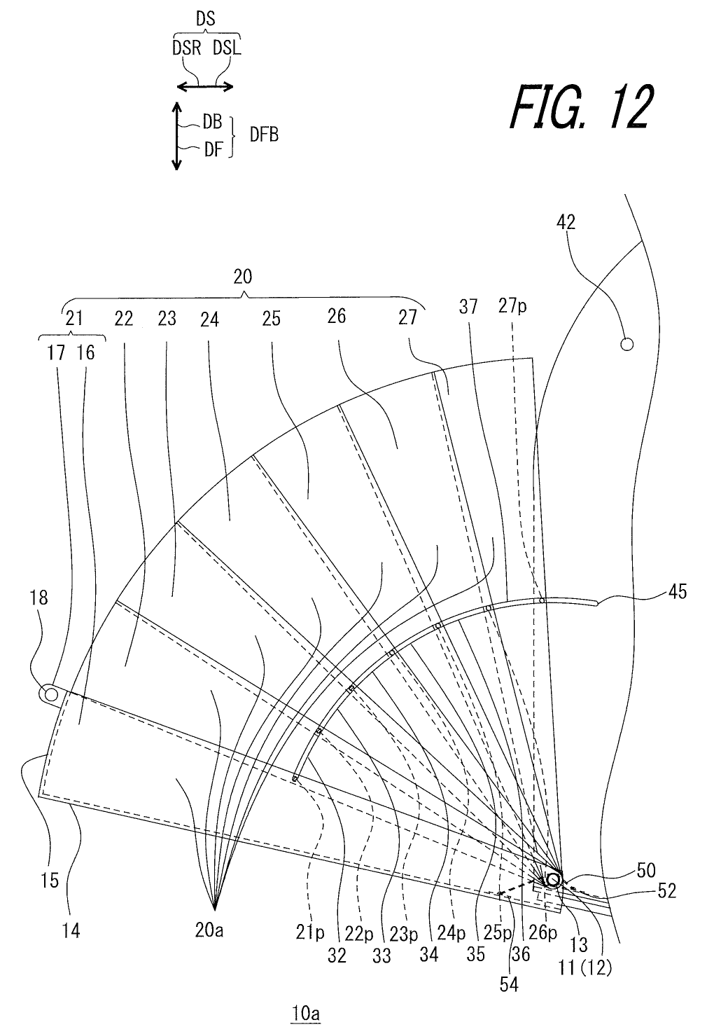

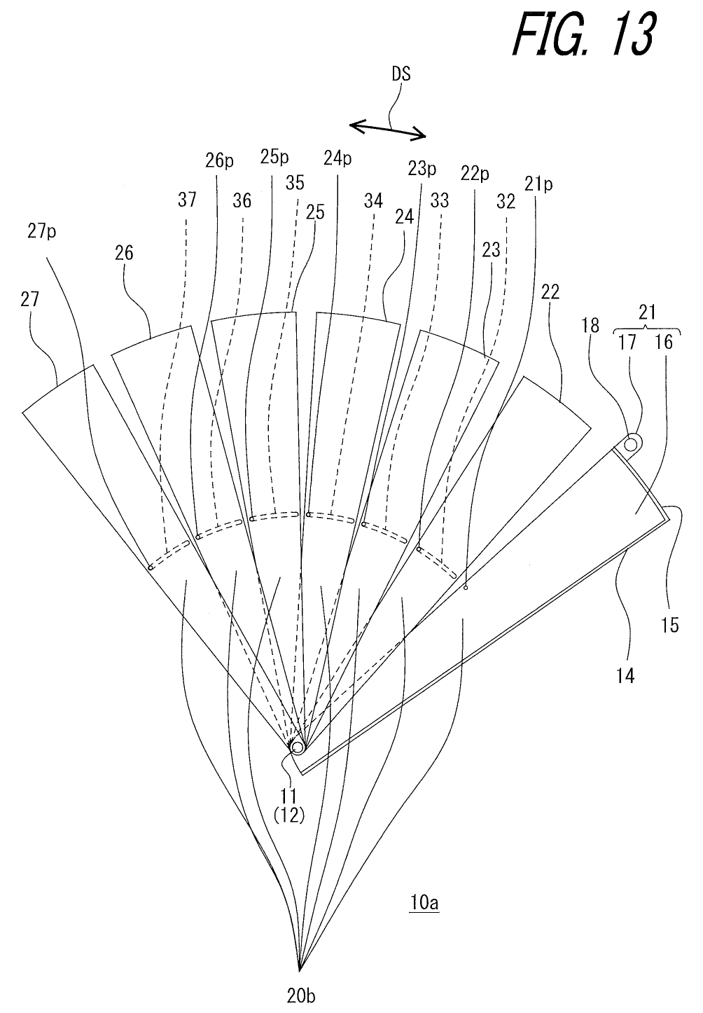

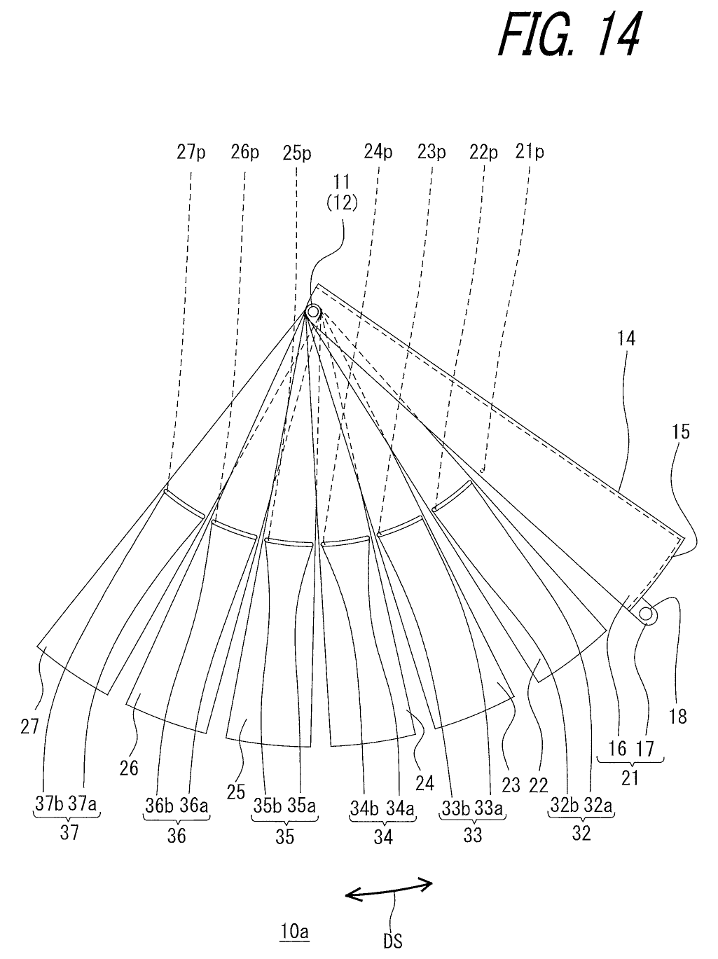

In the mower discharge chute assembly 10, the protrusions 22p to 27p are provided on the top surfaces 20a of the top plates 22 to 27, and the guide grooves 31 to 37 are provided on the bottom surfaces 20b of the top plates 21 to 27. However, the guide grooves may be provided on the top surfaces 20a of the top plates 22 to 27, and the protrusions may be provided on the bottom surfaces 20b of the top plates 21 to 27. FIGS. 12 to 14 show a mower discharge chute assembly 10a which is such a type of the mower discharge chute assembly. FIG. 12 shows an enlarged top view of a mower discharge chute assembly 10a when the folding top cover 20 is unfolded. FIG. 13 shows an exploded bottom view of the mower discharge chute assembly 10a when the folding top cover 20 is unfolded. FIG. 14 shows an exploded top view of the mower discharge chute assembly 10a when the folding top cover 20 is unfolded.

As shown in FIGS. 12 to 14, the guide grooves 32 to 37 are provided on the top surfaces 20a of the top plates 22 to 27. The protrusions 21p to 27p are provided on bottom surfaces 20b of the top plates 21 to 27. In this case, as shown in FIG. 12, instead of the protrusion 44, the guide groove 45 is provided on the outer top surface 4a of the mower deck 4. However, the positions of protrusions 21p to 27p, the first groove ends 31a to 37a, and the second groove ends 31b to 37b are different between the mower discharge chute assembly 10 and the mower discharge chute assembly 10a.

In the mower discharge chute assembly 10, as viewed in FIG. 7, the first groove ends 31a to 37a are farther groove ends of two groove ends of the top plates 21 to 27 to the first side plate 14, respectively, and the second groove ends 31b to 37b are closer groove ends of two groove ends of the top plates 21 to 27 to the first side plate 14, respectively. The protrusions 22p to 27p are provided such that the protrusions 22p to 27p overlap with the second groove ends 32b to 37b, respectively, as viewed along the pivot 12.

In the mower discharge chute assembly 10a, as viewed in FIG. 14, the first groove ends 32a to 37a are closer groove ends of two groove ends of the top plates 22 to 27 to the first side plate 14, respectively, and the second groove ends 32b to 37b are farther groove ends of two groove ends of the top plates 22 to 27 to the first side plate 14, respectively. The protrusions 22p to 27p are provided such that the protrusions 22p to 27p overlap with the second groove ends 32b to 37b, respectively, as viewed along the pivot 12.

Accordingly, remaining top plates 22 to 27 of the top plates 21 to 27 other than the distal top plate 21 has the guide grooves 32 to 37 on one surface of the top surface 20a and the bottom surface 20b and the protrusions 22p to 27p on another surface of the top surface 20a and the bottom surface 20b. The distal top plate 21 has one of the guide groove 31 and the protrusion 21p on the bottom surface 20b of the distal top plate 21. Furthermore, another of the guide groove 45 and the protrusion 44 is provided on the outer top surface 4a of the mower deck 4. The other of the guide groove 45 and the protrusion 44 is engaged with the one of the guide groove 37 and the protrusion 27p provided on the bottom surface 20b of the proximal top plate 27. However, the mower discharge chute assembly 10 is more preferable than the mower discharge chute assembly 10a, because dusts might be accumulated in the guide grooves 32 to 37 and 45 in the mower discharge chute assembly 10a, whereas the dusts are not accumulated in the guide grooves 31 to 36 in the mower discharge chute assembly 10.

The mower discharge chute assembly 10 and the mower discharge chute assembly 10a are robust and durable, designed to withstand the rigors of mowing operations. In a different configuration, the mower discharge chute assembly 10 and the mower discharge chute assembly 10a could be made from a variety of materials, including but not limited to metal alloys, composites, or reinforced plastics, depending on the desired strength, weight, and cost considerations. Additionally, the protrusions 21p to 27p and 44 may be coated with a low-friction material or treated to enhance its wear resistance.

The present application refers to words “include” and derivatives as nonrestrictive terms for description of provision of constituent elements, without exclusion of any other constituent element not referred to in the present application. The same applies to words “have”, “provided with”, and derivatives thereof.

Expressions “member”, “part”, “element”, “body”, and “structure” may have a plurality of meanings indicating a single portion and a plurality of portions.

Ordinal numbers “first”, “second”, and the like are terms for simple distinction among configurations, without having any other meaning (e.g. specific order). For example, provision of a “first element” does not indicate provision of a “second element”, and provision of the “second element” does not indicate provision of the “first element”.

Expressions “substantially”, “approximately”, “about”, and the like indicating degrees may each have a rational deviation not significantly changing a final result. All the numerical values referred to in the present application may be interpreted as including any one of the expressions “substantially”, “approximately”, “about”, and the like.

In the present application, an expression “at least one of A and B” is interpreted to encompass (1) only A, (2) only B, and (3) both A and B.

In view of the above disclosure, the present invention can obviously include various modifications and alterations. The present invention may thus be implemented in any manner different from those specifically disclosed in the present application without departing from the spirit of the preset invention.

What is claimed is:

1. A mower discharge chute assembly comprising:
a first side plate configured to cover a side opening of a mower deck;
a folding top cover connected to the first side plate and being foldable to have the side opening covered by the first side plate and unfoldable to have the side opening uncovered, the folding top cover comprising top plates configured to be stacked when the folding top cover is folded; and
a coupler provided on the mower deck adjacent to the side opening to movably couple the folding top cover to the mower deck.

2. The mower discharge chute assembly according to claim 1,
wherein the top plates comprising:
a distal top plate coupled to the first side plate; and
a proximal top plate provided opposite to the distal top plate such that the proximal top plate is closest to the mower deck among the top plates when the folding top cover is unfolded.

3. The mower discharge chute assembly according to claim 2,
wherein each of the top plates is fan-shaped, and
wherein the coupler includes a pivot of the fan-shaped top plates.

4. The mower discharge chute assembly according to claim 3,
wherein each of the top plates has a top surface and a bottom surface opposite to the top surface along the pivot, and
wherein each of remaining top plates of the top plates other than the distal top plate has a guide groove on one surface of the top surface and the bottom surface and a protrusion on another surface of the top surface and the bottom surface, the guide groove having an arc shape with respect to the pivot, the protrusion being engageable with the guide groove, and
wherein the distal top plate has one of the guide groove and the protrusion on the bottom surface of the distal top plate.

5. The mower discharge chute assembly according to claim 4, further comprising:
another of the guide groove and the protrusion which is provided on an outer top surface of the mower deck on which the top plates are provided and which is engaged with the one of the guide groove and the protrusion provided on the bottom surface of the proximal top plate.

6. The mower discharge chute assembly according to claim 5,
wherein the guide groove has a first groove end against which the protrusion abuts when the folding top cover is unfolded, and
wherein the guide groove has a second groove end opposite to the first groove end in a circumferential direction with respect to the pivot such that the second groove end is configured to abut against the protrusion to fold the top plates when the first side plate covers the side opening.

7. The mower discharge chute assembly according to claim 6, further comprising:
a spring configured to press the first side plate and a side wall of the mower deck to urge the folding top cover to open.

8. The mower discharge chute assembly according to claim 7, further comprising:
a lock pin configured to keep the folding top cover folded; and
a first pin hole into which the lock pin is to be inserted, the first pin hole being provided on the mower deck adjacent to the top plates stacked when the folding top cover is folded,
wherein the distal top plate has a fan-shaped portion and a projection protruding from the fan-shaped portion, the projection having a second pin hole through which the lock pin is configured to pass, the second pin hole being aligned with the first pin hole along the pivot when the folding top cover is folded.

9. The mower discharge chute assembly according to claim 3, further comprising:
a second side plate coupled to an arc side of the fan-shaped distal top plate,
wherein the first side plate is coupled to a radius side of the fan-shaped distal top plate.

10. The mower discharge chute assembly according to claim 3,
wherein the stacked top plates do not interface with a drive train provided on the mower deck when the folding top cover is closed,
wherein the folding top cover has a shape of an unfolded fan when the folding top cover is unfolded, and
wherein the folding top cover interferes with a drive train provided on the mower deck if the folding top cover has the shape of the unfolded fan when the first side plate covers the side opening.

11. A mower comprising:
a cutting blade rotatable to produce clippings;
a mower deck rotatably supporting the cutting blade and having an inner top surface facing the cutting blade and an outer top surface opposite to the inner top surface, the mower deck having a side opening positioned to allow for discharge of the clippings;
a drive train provided on the outer top surface of the mower deck;
a mower discharge chute assembly coupled to the mower deck and configured to open and close the side opening, the mower discharge chute assembly including:
a first side plate configured to cover the side opening;
a folding top cover connected to the first side plate and being foldable to have the first side plate covered by the first side plate and unfoldable to have the side opening uncovered, the folding top cover comprising top plates configured to be stacked when the folding top cover is folded; and
a coupler provided on the outer top surface of the mower deck adjacent to the side opening to movably couple the folding top cover to the outer top surface.

12. The mower according to claim 11,
wherein the top plates comprising:
a distal top plate coupled to the first side plate; and
a proximal top plate provided opposite to the distal top plate such that the proximal top plate is closest to the mower deck among the top plates when the folding top cover is unfolded.

13. The mower according to claim 12,
wherein each of the top plates is fan-shaped, and
wherein the coupler includes a pivot of the fan-shaped top plates.

14. The mower according to claim 13,
wherein each of the top plates has a top surface and a bottom surface opposite to the top surface along the pivot, and
wherein each of remaining top plates of the top plates other than the distal top plate has a guide groove on one surface of the top surface and the bottom surface and a protrusion on another surface of the top surface and the bottom surface, the guide groove having an arc shape with respect to the pivot, the protrusion being engageable with the guide groove, and
wherein the distal top plate has one of the guide groove and the protrusion on the bottom surface of the distal top plate.

15. The mower according to claim 14,
wherein the mower discharge chute assembly further comprises another of the guide groove and the protrusion which is provided on the outer top surface of the mower deck and which is engaged with the one of the guide groove and the protrusion provided on the bottom surface of the proximal top plate.

16. The mower according to claim 15,
wherein the guide groove has a first groove end against which the protrusion abuts when the folding top cover is unfolded, and
wherein the guide groove has a second groove end opposite to the first groove end in a circumferential direction with respect to the pivot such that the second groove end is configured to abut against the protrusion to fold the top plates when the first side plate closes the side opening.

17. The mower according to claim 16,
wherein the mower discharge chute assembly further comprises a spring configured to press the first side plate and a side wall of the mower deck to urge the folding top cover to open.

18. The mower according to claim 17,
wherein the mower discharge assembly further comprises:
a lock pin configured to keep the folding top cover folded; and
a first pin hole into which the lock pin is to be inserted, the first pin hole being provided on the mower deck adjacent to the top plates stacked when the folding top cover is folded,
wherein the distal top plate has a fan-shaped portion and a projection protruding from the fan-shaped portion, the projection having a second pin hole through which the lock pin is configured to pass, the second pin hole being aligned with the first pin hole along the pivot when the folding top cover is folded.

19. The mower according to claim 13,
wherein the mower discharge assembly further comprises a second side plate coupled to an arc side of the fan-shaped distal top plate,
wherein the first side plate is coupled to a radius side of the fan-shaped distal top plate.

20. The mower according to claim 13,
wherein the stacked top plates do not interface with the drive train when the folding top cover is closed,
wherein the folding top cover has a shape of an unfolded fan when the folding top cover is unfolded, and
wherein the folding top cover interferes with the drive train if the folding top cover has the shape of the unfolded fan when the first side plate covers the side opening.
